(19) United States
(12) Patent Application Publication
(10) Pub. No.: US 2006/0035480 A1
(43) Pub. Date: Feb. 16, 2006

(54) Method for transmitting data using a releasable connector

(75) Inventors: Scott J. Boyd, Pflugerville, TX (US); Raymundo Lopez, Austin, TX (US); Andrew T. Sultenfuss, Leander, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/252,706

(22) Filed: Oct. 18, 2005

Related U.S. Application Data
(62) Division of application No. 10/431,381, filed on May 7, 2003.

(51) Int. Cl. H01R 11/30

(52) U.S. Cl. 439/39

(57) ABSTRACT

A method and system for releasing a reusable breakaway media connection is disclosed. The connector includes a coupling element that may be released via an automated process. The connector may be used to efficiently convey data to and from an information handling system.

### CROSS-REFERENCE TO RELATED APPLICATIONS

This application is a division of application Ser. No. 10/431,381, filed May 7, 2003, which is incorporated herein by reference.

### TECHNICAL FIELD

This invention relates, in general, to information handling systems, and, more particularly, to a releasable connector that may be coupled to an information handling system and may convey data.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems include a network receptacle into which a network cable may be inserted. Data may be conveyed to and from the computer via the network cable. Additionally, software may be uploaded or downloaded via the network cable. Typical network cables use an RJ45 or RJ11 connector. A connector that maintains its locked state may be problematic if a unit is moved without releasing the connector.

Probe style fingers have been employed for automated test fixtures, but these are expensive and delicate. Breakaway blocks have also been used as releasable connectors but such blocks remain with an information handling system until the system is packaged. Conventional RJ45 and RJ11 connectors typically require the removal of the cable by a manual step. Automated methods have been developed to depress the locking tab on RJ45 or RJ11 connectors, but such automated methods are not sufficiently reliable nor robust.

### SUMMARY OF THE INVENTION

In accordance with the present disclosure, one implementation of a releasable connector may include one or more conductors supported by a housing. The one or more conductors may be capable of conveying data. A coupling element may be coupled to the housing. The coupling element may be a magnetic coupling element. The magnetic coupling element may be a magnet or ferrous material. The coupling element may also be a frictional coupling element. The housing of the releasable conductor may be transparent. The housing may also be opaque.

In general, in another aspect, the present disclosure relates to a method of conveying data to and from an information handling system. The method may include mating a releasable connector to an information handling system. The releasable connector may include one or more conductors supported by a housing. The one or more conductors may be capable of conveying data. The method may also include conveying data to the information handling system through the releasable connector. The method may include releasing the connector from the information handling system.

In general, in another aspect, the present disclosure relates to a method of manufacturing an information handling system. The information handling system may be connected to a test station. The method may include mating a releasable connector to the information handling system. The releasable connector may include one or more conductors supported by a housing. The one or more conductors may be capable of conveying data. A magnetic coupling element may be coupled to the housing. A test station may be coupled to at least one of the conductors. Data may be conveyed between the information handling system and the test station.

One technical advantage of a releasable connector is its ease of use. RJ45-based connectors and RJ11-based connectors have a locking tab that must be depressed before the connector can be removed from its mating receptacle. A connector with a locking mechanism that may be released by applying a force to the associated cable, the mating receptacle, or the releasable connector is easier to use.

Another technical advantage of a releasable connector is enhancing the lifespan of the connector. A locking tab may become damaged with use. Without a locking tab, the releasable connector may have a longer life.

Another technical advantage of a releasable connector is the facilitation of efficient transfer of data to or from an information handling system. For high volume applications, depressing the locking tab on a network cable requires additional labor. Releasing the connector by applying force to the associated cable, to the releasable connector, or to the mating receptacle provides a method for conveying data to or from an information handling system that is amendable to automation.

Another technical advantage of a releasable connector is providing efficient system for uploading or downloading software to an information handling system. For high volume applications, depressing the locking tab on a network cable requires additional labor. Releasing the connector by applying force to the associated cable, to the releasable connector, or to the mating receptacle provides a method for uploading or downloading software to an information handling system that may be automated.

Another technical advantage of a releasable connector is providing a connector that may be easily disconnected from an information handling system, but strong enough to maintain a positive connection during the software or data download or upload.

Other technical advantages will be apparent to those of ordinary skill in the art in view of the following specification, claims and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a perspective view of an example of a releasable connector;

FIG. 1A is an end view of an example of a releasable connector;

FIG. 2 is a back view of an example computer;

FIG. 3 is an example breakaway harness for an example computer;

FIG. 3A is an example releasable connector; and

FIG. 4 is an example releasable connector.

### DETAILED DESCRIPTION OF THE PREFERRED EMBODIMENTS

Cables based upon a standard connector are used in many information handling systems. A standard RJ11 or RJ45 cable, for example, requires that a locking tab be depressed before the standard connector may be removed from the information handling system. Before the system is moved, any RJ11 or RJ45 connectors need to be removed because these connectors remain in a locked position until the locking tab is depressed. The following examples provide a method for efficient connection and disconnection of a cable to an information handling system, and at the same time maintain a connection the permits the downloading or uploading of data or software to the information handling system.

An information handling system, such as a computer, typically includes a network connection or port to facilitate the transfer of information to and from the information handling system. For example, an information handling system may contain an RJ45-based network receptacle that may be mated with an RJ45-based network cable. A representative RJ45 cable contains a locking tab or tang and may contain eight individual conductors or wires. The locking tab is required to maintain physical and electrical connectivity between the individual conductors of the RJ45 connector and the network receptacle on the computer. The inclusion of a locking tab on a RJ45 connector may require a manual step to release the connector from its receptacle.

To eliminate or minimize any steps requiring user intervention, a releasable connector element may be used. Example releasable connectors should not include a locking tab, such as the tab on a RJ45 connector, or other locking mechanism requiring user intervention. Additionally, the locking tab on a connector, such as an RJ45 connector, may be damaged during use. Having a coupling element that does not require a physical locking tab creates a releasable connector with an enhanced lifespan. The disclosed embodiments provide an approach that minimizes the harm or damage to either the connector or the receptacle with which the connector is mated.

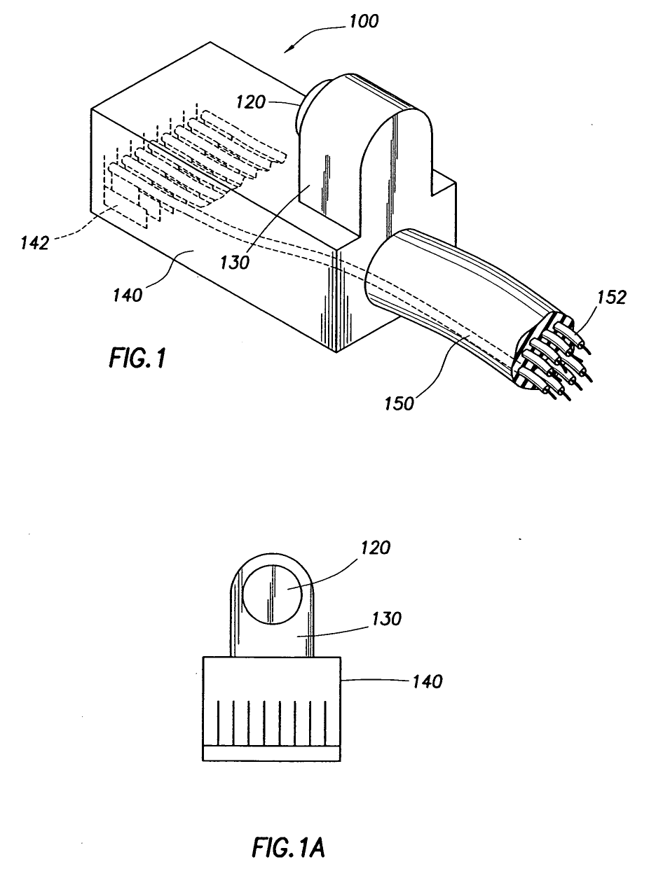

Turning to FIG. 1, a releasable connector 100 may include a housing 140. Housing 140 performs various functions. One example function is to provide a structural element for the releasable connector that may be mated with a receptacle. Housing 140 may be fabricated according to the physical dimensions of a mating receptacle. Example connectors include the RJ45 connector and the RJ11 connector. Housing 140 also supports the cable 150. Additionally, part of the housing (labeled 130) may support the releasable coupling element 120 Releasable connector 100 may be fabricated using a RJ45 or RJ11 connector, but removing the locking tab from the connector.

As shown in FIG. 1, cable 150 may include a plurality of conductors 152. For example, conductor 150 may be a CAT5 or CAT5e compatible cable. In the example shown in FIG. 1, cable 150 includes eight independent conductors 152. The dotted lines in FIG. 1 represent the external connections for the individual conductors 152 where the plurality of conductors mate with a mating receptacle. Each conductor interfaces with the external environment through contact 142. A locking tab (or tang) that is included in standard RJ45 connectors is not included in connector 100 shown in FIG. 1.

To maintain coupling between connector 100 and its mating receptacle, coupling should be provided between connector 100 and its mating receptacle. In the example shown in FIG. 1, coupling is provided by releasable element 120. The releasable element may be any element that may be released under mechanical, electrical, magnetic, chemical, electromagnetic, or optical conditions. In one example, coupling element 120 is a magnet, and the mating receptacle is proximate to a ferrous material that can be coupled to a magnet. The magnet may be chosen to have sufficient flux to maintain physical and electrical coupling between connector 100 and the mating connector. In one example, the magnetic coupling element produces about five pounds of force before it may be released from its mating receptacle. The releasable connector when mated with a mating receptacle surrounded by a ferrous material disclosed herein may provide sufficient coupling force to ensure connectivity between the releasable connector 100 and its mating receptacle.

A magnetic coupling element 120 may be released from a mating receptacle by applying a force in the direction of the magnetic flux. In example systems, the force may be applied on the housing 140, on the cable 150, or to an associated mating receptacle. For example, pulling on conductor 150 may be sufficient to remove connector 100 from its mating receptacle. In another example, force may be applied to the mating receptacle or to a surface connected to the mating receptacle.

An end view of releasable connector 100 is shown in FIG. 1A. The connector shown in FIG. 1A includes a magnetic coupling element 120, the support 130 for the coupling element 120, and housing 140. Support 130 may be a portion of housing 140. In one example, housing 140 may be fabricated from an opaque material. In another example, housing 140 may be fabricated from a transparent or partially transparent material that permits light to pass through the releasable connector. A transparent housing may be used, for example to detect light that may be transmitted through the housing. For example, light emitted from a light emitting diode (LED) located near the mating receptacle may be detected by a detector located at the conductor side of connector 100.

Coupling element 120 need not be limited to a magnetic element. The magnetic element need not be limited to coupling element 120. In another example, coupling element 120 may be a ferrous material or other material or other material that is attracted to a magnetic source. A magnetic element may be placed near the mating receptacle and ferrous material 120 may then couple to the magnetic element. When mated with the receptacle, the coupling between connector 100 and the receptacle maintains electrical and physical contact of connector 100 to receptacle.

The magnetic coupling element may provide a method to control the amount of force used to maintain the connection between the connector and its receptacle. Increasing the magnetic flux would provide a harder or tighter seal between the connector and its receptacle. The controllable magnetic element may be attached to the conductor 100, the receptacle with which the conductor is mated, or to both the conductor and receptacle.

The releasable connector need not be limited to one based on magnetic coupling. For example, the coupling between the connector and receptacle may be maintained by a non-ferrous coupling element. In one implementation, the non-ferrous element couples connector 100 to a mating receptacle using frictional or physical contact. One such example is the use of Velcro as a non-ferrous coupling element. In still another alternative, the releasable connector need not be limited to an RJ45 connector. For example, a releasable connector that is compatible with the RJ11 standard may be fabricated.

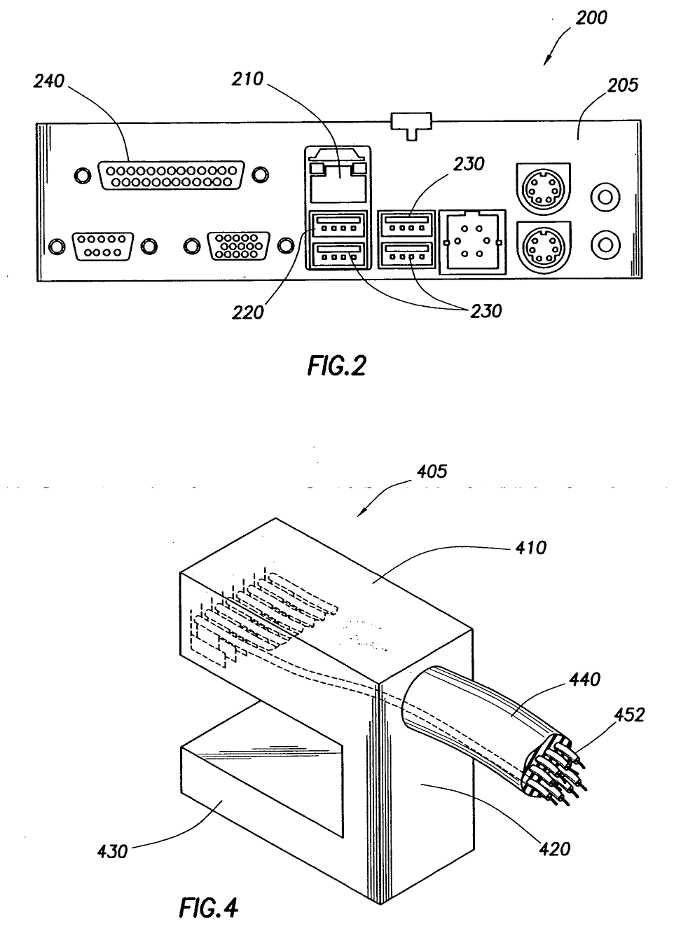

The releasable connector may be mated with example computer 200 as shown in FIG. 2. FIG. 2 illustrates the back of an example computer that includes a stacked USB 220 and RJ45 network connection 210. Also shown are three USB ports 230.

In one example the back plate 205 of computer 200 may be fabricated from a ferrous material. The ferrous back plate 205 provides a support that attracts a magnetic coupling element 120. In one implementation of a releasable connector, an RJ45-based connector 100 with a magnetic coupling element is inserted into the RJ45 network receptacle 210. When mated, connector 100 maintains its coupling with the network receptacle 210 until the connector is released by applying a force to connector 100 to remove connector 100 from receptacle 210. The magnetic releasable latch may attach to the back plate 205 above the network port 210.

The releasable connector permits quick and efficient disconnection of the interface or coupling between the connector and its mating receptacle. For example, an RJ45-based releasable connector permits efficient disconnection of the network interface from the computer chassis shown in FIG. 2. In one example, about three pounds of force is required to release the connector. The releasable connector disclosed herein creates a positive lock between the connector and its receptacle and ensures connectivity between the connector and its mating receptacle. Additionally, the releasable connector is amenable to automation as the disconnection does not require manipulation of the connector/receptacle mating unit.

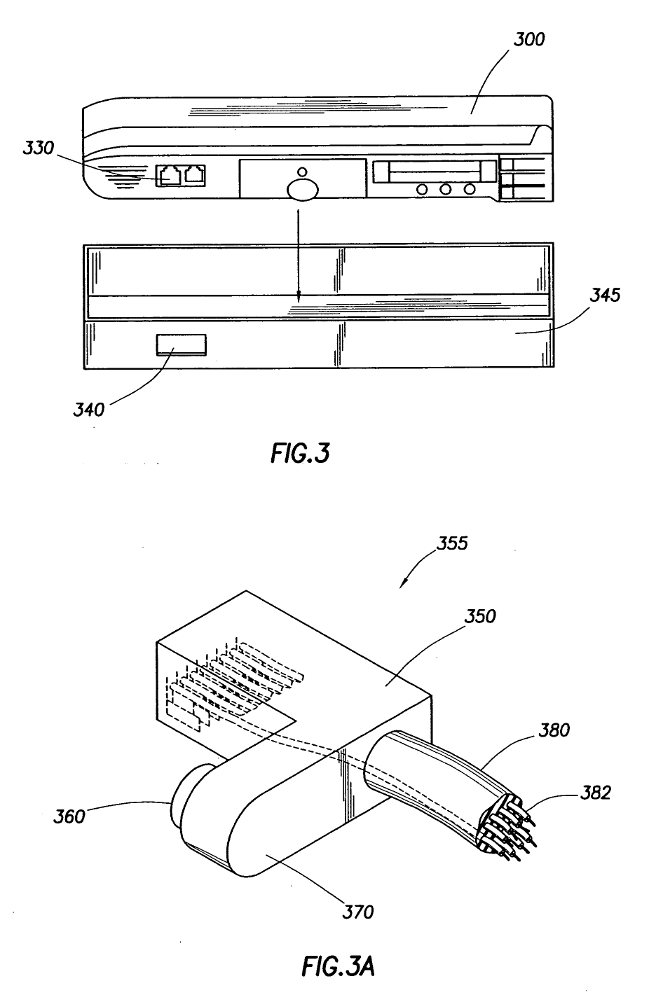

In an alternative example, a releasable connector may be mated with a computer, such as the notebook computer 300 that lacks a ferrous support surrounding the network receptacle. In one implementation, the locking mechanism is based on an offset magnetic connection. As shown in FIG. 3, the notebook computer 300 may be placed in a ferrous tray or frame 345 that includes a port 340 to access the network receptacle 330. One implementation of a releasable connector that may mate with notebook computer 300 and ferrous frame 345 is shown in FIG. 3A. Releasable connector 355 includes a cable 380, a housing 350, a releasable coupling element 360, and a support 370. Support 370 may be included as a portion of housing 350. Cable 380 may include a plurality of conductors 382. In one example, housing 350 is compatible with the RJ45 standard. In one implementation, connector 355 is inserted into network receptacle 330 through port 340 of the computer shown in FIG. 3. The magnetic coupling element mates with frame 345 and couples the releasable connector 355 to network receptacle 330. Frame 345 may also be known as a breakaway harness. A computer inserted into breakaway harness 345 and attached to a releasable connector 355 may be disconnected from the connector 355 by moving the computer away from the breakaway harness. In another example, housing 350 is compatible with the RJ11 standard.

Other types of breakaway harnesses may be implemented. For example, the notebook computer may be fabricated with a ferrous material located sufficiently close to the network connector to permit the direct use of a magnetic coupling element. The breakaway harness may also be used in a desktop computer setting. The desktop may also include a ferrous material to enhance the magnetic coupling of the connector with its receptacle. Furthermore, a frictional coupling mechanism such as Velcro may be used to attach a releasable connector to its mating receptacle.

The coupling element need not be limited to a magnetic element or Velcro. As shown in FIG. 4, a frictional element may be used to couple a releasable connector to a computer. FIG. 4 shows an example connector that is based on friction retention by piggybacking a tabless network connector above a USB connector. For example, the computer back plate 205 in FIG. 2 has a geometric relationship between network receptacle 210 and USB port 220. Because a fixed relationship exists between the network connector 210 and USB port 220, the USB port 220 may be used as a frictional coupling element to maintain a connection between the RJ45 network receptacle 210 and a network releasable connector. A parallel port 240 is also shown in the back of computer 200. Releasable connector 405 may be fabricated according to the geometric relationship between network receptacle 210 and USB port 220. The connector 405 includes a housing 410, a coupling element 430, a support element 420, and a cable 440. Support element 420 may be included as a portion of housing 410. Cable 440 may include a plurality of conductors 452.

Housing 410 may be fabricated according to a standard such as RJ45 or RJ11, except that housing 410 lacks a locking tab. Housing 410 may be fabricated to mate with a mating receptacle such as the RJ45 receptacle 210 on the backplate 205 shown in FIG. 2. The distance between the RJ45-based housing and the USB coupling element 430 may be chosen to match the distance between a network receptacle and USB port shown in FIG. 2. As a result, the RJ45-based housing 410 may be coupled to the network receptacle 210, and at the same time the USB coupling element 430 may be coupled to USB port 220. Although a USB connection lacks locking tabs, it is a friction based locking approach. Following insertion into a USB port, a USB plug maintains its coupling with the USB port. The connection between the coupling element 430 and USB port 220 provides the force to maintain the coupling between releasable housing 410 and network receptacle 210. The coupling of a USB connector can be efficiently broken by pulling the USB connector away from its mating USB receptacle. Consequently, removal of the USB coupling element 430 removes the releasable connector from its mating receptacle.

The releasable connectors disclosed herein are applicable for efficiently uploading and downloading data to a computer. In one example, a network cable may be attached to network port 210 during computer manufacturing. During manufacturing, the computer may be coupled via a network connection to a test station. A computer may receive software from the test station through a network receptacle for loading onto the machine during manufacturing. The network connection may be released by pulling the network cable from the computer. Alternatively, the computer may be pulled away from the network receptacle.

The use of a releasable connector eliminates the requirement of an operator to manually remove a cable from a computer during its manufacture. For example, in the case of a magnetic or frictional-based coupling, the connector mounts into the network receptacle. Removal of the coupling between the connector and its receptacle may occur in a non-damaging or non-destructive fashion. For example, due to the absence of a locking tab, no destruction of the locking tab (which may result in concomitant damage to the connector) occurs. Furthermore, the disclosed breakaway harness shown in FIG. 3 permits the use of a magnetic releasable connector during its manufacture or at a later time point. When using a breakaway harness, the coupling of the releasable connector may occur regardless of whether the machine has sufficient ferrous material to couple with the releasable connector. Additionally, because the releasable conductor operates in a non-destructive fashion, the disclosed connectors are reusable over a large period of time.

In another example, data may be entered into the computer from a test station through the network connection 220. In an alternative implementation, data from the computer may be exported to an external source, such as a test station. For example, the disclosed methods and apparatus could be used to transfer diagnostic information about the computer during the manufacturing process of the computer.

In still another implementation, a releasable connector may be used to upload or download software to a computer. For example, a user who installs software on notebook computers or on other types of information handling systems may insert the releasable connector into the computer, transfer the software to the computer, and either extract the machine from the connector or extract the releasable connector from the computer. Accordingly, a network cable with a releasable connector is placed in the RJ45 network connector of the computer, if any. Software is then loaded onto the computer. The machine or releasable connector may be extracted by pulling the machine or the releasable connector away from the other. Because of the absence of a locking tab, an operator is not needed to remove the locking tab of any connector such as an RJ45. In an alternative example, data from the computer may be transferred to an external source. For example, the disclosed methods and apparatus could be used to transfer diagnostic information about the computer.

This disclosure is not limited to computer systems, but may be applied to any information handling system. Although the present disclosure has been described in detail, it should be understood that various changes, substitutions, and alterations can be made hereto without departing from the spirit and the scope of the invention as defined by the appended claims.

What is claimed is:

1. A method for transmitting data, comprising:
providing a computer system, wherein the computer system comprises,
a processor; and
a memory communicatively coupled to the processor;
providing a releasable connector, wherein the releasable connector comprises,
one or more conductors supported by a housing, wherein each of the conductors is capable of transmitting data; and
a magnetic coupling element coupled to the housing;
mating the releasable connector to the computer system;
transmitting data to or from the computer system through the conductors of the releasable connector; and
releasing the connector from the computer system.

2. The method for transmitting data of claim 24,
wherein the computer system includes a back plate formed of a ferrous material; and
wherein the step of mating the releasable connector to the computer system comprises the step of mating the magnetic coupling element of the releasable connector to the back plate of the computer system.

3. The method for transmitting data of claim 24, wherein the housing of the releasable connector is substantially transparent.

4. The method for transmitting data of claim 24, wherein the housing of the releasable connector is substantially opaque.

5. The method for transmitting data of claim 1, wherein the releasable connector includes a frictional coupling element for mating the releasable connector to the computer system.

6. A method for transmitting data, comprising:
providing an information handling system, wherein the information handling system comprises,
a processor; and
a memory communicatively coupled to the processor;
providing a releasable connector, wherein the releasable connector comprises,
one or more conductors supported by a housing, wherein each of the conductors is capable of transmitting data; and
a magnetic coupling element coupled to the housing;
mating the releasable connector to the information handling system;
transmitting data to or from the information handling system through the conductors of the releasable connector; and
releasing the connector from the information handling system.

7. The method for transmitting data of claim 6,
wherein the information handling system includes a back plate formed of a ferrous material; and
wherein the step of mating the releasable connector to the information handling system comprises the step of mating the magnetic coupling element of the releasable connector to the back plate of the information handling system.

8. The method for transmitting data of claim 6, wherein the housing of the releasable connector is substantially transparent.

9. The method for transmitting data of claim 6, wherein the housing of the releasable connector is substantially opaque.

10. The method for transmitting data of claim 6, wherein the releasable connector includes a frictional coupling element for mating the releasable connector to the information handling system.
